(19) United States
(12) Patent Application Publication
(10) Pub. No.: US 2014/0068179 A1
(43) Pub. Date: Mar. 6, 2014

(54) PROCESSOR, INFORMATION PROCESSING APPARATUS, AND CONTROL METHOD

(71) Applicant: FUJITSU LIMITED, Kawasaki-shi (JP)

(72) Inventors: Koichi ONODERA, Kawasaki (JP); Toru HIKICHI, Inagi (JP); Hiroyuki KOJIMA, Kawasaki (JP); Ryotaro TOH, Kawasaki (JP)

(21) Appl. No.: 13/905,024

(22) Filed: May 29, 2013

(30) Foreign Application Priority Data
Aug. 31, 2012 (JP) 2012-192692

(51) Int. Cl. G06F 12/08

(52) U.S. Cl. CPC G06F 12/0866
USPC 711/113

(57) ABSTRACT

A processor includes a cache memory that holds data from a main storage device. The processor includes a first control unit that controls acquisition of data, and that outputs an input/output request that requests the transfer of the target data. The processor includes a second control unit that controls the cache memory, that determines, when an instruction to transfer the target data and a response output by the first processor on the basis of the input/output request that has been output to the first processor is received, whether the destination of the response is the processor, and that outputs, to the first control unit when the second control unit determines that the destination of the response is the processor, the response and the target data with respect to the input/output request.

### CROSS-REFERENCE TO RELATED APPLICATION

This application is based upon and claims the benefit of priority of the prior Japanese Patent Application No. 2012-192692, filed on Aug. 31, 2012, the entire contents of which are incorporated herein by reference.

### FIELD

The embodiments discussed herein are related to a processor, an information processing apparatus, and a control method.

### BACKGROUND

There is a known conventional technology called Non Uniform Memory Access (NUMA). In this technology, multiple memories are paired with central processing units (CPUs), which function as processors that manage the data stored in the memories, and the CPUs share the memories. A known example of NUMA technology is cache coherent Non Uniform Memory Access (ccNUMA), in which a CPU holds, by using a directory, coherency between the data that is stored in a memory to which the CPU is connected and the data that is stored in a cache memory by other CPUs.

With the CPUs that use this ccNUMA technology, if data in a memory that is managed by a first CPU is held in a cache memory by a second CPU and, furthermore, if a third CPU requests a transfer of the data, the first CPU may possibly allow the second CPU that holds the data in the cache memory to transfer the data. In the following, a process of transferring data performed by CPUs that uses the ccNUMA technology will be described with reference to FIGS. 22 to 27.

In the description below, a CPU that manages the coherency of data that is targeted for transfer (hereinafter, referred to as “transfer target data”) is represented by a Home-CPU (H-CPU) and a CPU that requests a data transfer from the H-CPU is represented by a Local-CPU (L-CPU). Furthermore, a CPU that has already held the transfer target data in a cache memory from the memory that is managed by the H-CPU is represented by a Remote-CPU (R-CPU). Furthermore, it is assumed that the L-CPU is connected to various Input Output (IO) devices via a Peripheral Component Interconnect Express (PCIe).

FIG. 22 is a schematic diagram illustrating a data transfer process performed among three conventional CPUs. For example, an Interface Controller (IC) 52 in an L-CPU 51 controls an IO process with IO devices via a PCIe 53. A Level 2 (L2) cache unit 55, which is a secondary cache memory included in an H-CPU 54, holds, by using a directory, the coherency between the data stored in a memory 56 and the data held in a cache memory from the memory 56 by another CPU. An L2 cache unit 58 included in an R-CPU 57 holds, in its own cache memory via the L2 cache unit 55, the data stored in the memory 56.

At this point, if the IC 52 receives a request for data stored in the memory 56 via the PCIe 53, the IC 52 issues, to the H-CPU 54, an IO request that requests a transfer of the data. Then, the L2 cache unit 55 included in the H-CPU 54 checks directory information on the transfer target data.

If the directory information is “R-EX (Exclusive)”, i.e., if the directory information indicates that data has been updated by the R-CPU 57 and then is held exclusively in a cache memory, the L2 cache unit 55 issues a data transfer request to the R-CPU 57. Then, the L2 cache unit 58 included in the R-CPU 57 issues, to the H-CPU 54, a data transfer response including the transfer target data. Then, the L2 cache unit 55 included in the H-CPU 54 transmits, to the IC 52, the transfer target data and an IO response and ends the data transfer process.

In the following, the number of times a data transfer is performed from when the IC 52 issues an IO request until the IC 52 receives both an IO response and data will be described with reference to FIG. 23. FIG. 23 is a timing chart illustrating the data transfer process performed among the three conventional CPUs. As illustrated in FIG. 23, first, the IC 52 issues an IO request to the H-CPU 54 (Step S201).

Then, the L2 cache unit 55 included in the H-CPU 54 issues, to the R-CPU 57, a data transfer request (Step S202). Then, the L2 cache unit 58 included in the R-CPU 57 issues, to the H-CPU 54, a data transfer response including the transfer target data (Step S203). Thereafter, the L2 cache unit 55 included in the H-CPU 54 transmits, to the IC 52 included in the L-CPU 51, the data and an IO response (Step S204) and ends the data transfer process.

As described above, in the conventional data transfer process performed among the three CPUs, communication among the CPUs is performed four times from when the IC 52 issues an IO request until the IC 52 receives the IO response and the data. To reduce the number of times the communication is performed among CPUs and to improve the efficiency of the data transfer process, it is conceivable to use a technology that directly transfers data from the R-CPU to the L-CPU.

In the following, a process of directly transferring data to the L-CPU 51 performed by the R-CPU 57 will be described with reference to FIG. 24. FIG. 24 is a schematic diagram illustrating a process for directly transferring data to an L-CPU. For example, the IC 52 issues an IO request to the H-CPU 54. Then, the L2 cache unit 55 included in the H-CPU 54 determines that the directory information is “R-EX” and then issues a data transfer request to the R-CPU 57.

Then, the L2 cache unit 58 included in the R-CPU 57 directly transfers both an IO response and data to the IC 52 included in the L-CPU 51 and issues a data transfer response to the H-CPU 54. Thereafter, the L2 cache unit 55 included in the H-CPU 54 issues an IO response to the IC 52 and ends the data transfer process.

In the following, when data is directly transferred from the R-CPU 57 to the L-CPU 51, the number of times the data transfer is performed from when the IC 52 issues an IO request until the IC 52 receives both an IO response and data will be described with reference to FIG. 25. FIG. 25 is a timing chart illustrating the process for directly transferring the data to the L-CPU. As illustrated in FIG. 25, the IC 52 issues an IO request to the H-CPU 54 (Step S301).

Then, the L2 cache unit 55 in the H-CPU 54 issues a data transfer request to the R-CPU 57 (Step S302). Then, the L2 cache unit 58 in the R-CPU 57 issues a data transfer response to the H-CPU 54 (Step S303) and issues both an IO response and data to the IC 52 (Step S304). Furthermore, the L2 cache unit 55 in the H-CPU 54 that has received the data transfer response issues an IO response to the IC 52 (Step S305).

As described above, if the R-CPU 57 directly transfers data to the IC 52, the number of times the communication among the CPUs is performed from when the IC 52 issues an IO request until it receives both the IO response and data can be reduced to three. Consequently, the L-CPU 51 promptly performs the data transfer process.
Patent Document 1: Japanese Laid-open Patent Publication No. 2001-282764
Non-Patent Document 1: Computer Architecture: A Quantitative Approach, 4^{th} Edition, John L. Hennessy, David A. Patterson, pp. 230-237

However, the problem with the technology that directly transfers transfer target data from an L-CPU to an R-CPU is that, if the L-CPU and the R-CPU are the same CPU, the performance of the data transfer is degraded.

FIG. 26 is a schematic diagram illustrating a data transfer performed when an L-CPU and an R-CPU are the same. In the description below of the example illustrated in FIG. 26, the L-CPU 51 includes an L2 cache unit 59 and also functions as an R-CPU that holds data in the memory 56 in a cache memory. In the description below, the L-CPU 51 that also functions as an R-CPU is represented by the L-CPU=R-CPU 51.

For example, the IC 52 issues an IO request to the H-CPU 54. Then, the L2 cache unit 55 checks the directory information on the transfer target data. If the directory information is “R-EX”, the L2 cache unit 55 identifies the CPU as the L-CPU=R-CPU 51 that holds the transfer target data in its own cache memory. Then, the L2 cache unit 55 issues a data transfer request to the L-CPU=R-CPU 51.

At this point, because the L2 cache unit 59 does not have a way to transmit an IO response and data to the IC 52, the L2 cache unit 59 issues a data transfer response including the transfer target data to the H-CPU 54. Then, the L2 cache unit 55 in the H-CPU 54 issues both an IO response and data to the IC 52 and ends the data transfer process.

In the following, the number of times the data transfer is performed from when the IC 52 issues an IO request until the IC 52 receives an IO response and data will be described with reference to FIG. 27. FIG. 27 is a timing chart illustrating the data transfer performed when the L-CPU and the R-CPU are the same. For example, the IC 52 issues an IO request to the H-CPU 54 (Step S401).

Then, the L2 cache unit 55 included in the H-CPU 54 determines that the L-CPU=R-CPU 51 is an R-CPU and then issues a data transfer request to the L-CPU=R-CPU 51 (Step S402). Then, the L2 cache unit 59 included in the L-CPU=R-CPU 51 transmits a data transfer response including the data to the H-CPU 54 (Step S403). Then, the L2 cache unit 55 included in the H-CPU 54 issues both an IO response and the data to the IC 52 (Step S404).

As described above, with the technology that directly transfers transfer target data to an R-CPU, if an L-CPU and an R-CPU are the same CPU, communication between the CPUs is performed four times from when the IC 52 issues an IO request until the IC 52 receives the IO response and the data. Consequently, with the technology that directly transfers transfer target data to an R-CPU, if an L-CPU and an R-CPU are the same CPU, the performance of the data transfer is degraded.

Furthermore, with the technology that directly transfers transfer target data to an R-CPU, the destination of the CPU to which an R-CPU issues data is different depending on whether the L-CPU and R-CPU are different or the same. Consequently, a process performed by the R-CPU becomes complicated and thus it is difficult to design CPUs.

### SUMMARY

According to an aspect of an embodiment, a processor includes a cache memory that holds data from a main storage device connected to a first processor. The processor includes a first control unit that controls acquisition of data performed by a input/output device connected to the processor and that outputs, to the first processor connected to the processor when the input/output device requests a transfer of target data stored in the main storage device connected to the first processor, an input/output request that requests the transfer of the target data. The processor includes a second control unit that controls the cache memory, that determines, when an instruction to transfer the target data and a response output by the first processor on the basis of the input/output request that has been output to the first processor is received from the first processor, whether the destination of the response is the processor, and that outputs, to the first control unit when the second control unit determines that the destination of the response is the processor, the response and the target data with respect to the input/output request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of the configuration of an information processing apparatus according to a first embodiment;

FIG. 2 is a schematic diagram illustrating an example of the configuration of an SB according to the first embodiment;

FIG. 3 is a schematic diagram illustrating an example of directory information;

FIG. 4 is a schematic diagram illustrating the directory status;

FIG. 5 is a schematic diagram illustrating an example of a CPU according to the first embodiment;

FIG. 6 is a schematic diagram illustrating an example of an IO request;

FIG. 7 is a schematic diagram illustrating an example of an IO response;

FIG. 8 is a schematic diagram illustrating an example of a data transfer request;

FIG. 9 is a schematic diagram illustrating an example of a data transfer response;

FIG. 10 is a schematic diagram illustrating the flow of a data transfer performed by CPUs according to the first embodiment;

FIG. 11 is a timing chart illustrating the flow of the data transfer performed by the CPUs according to the first embodiment;

FIG. 12 is a schematic diagram illustrating the flow of a data transfer performed by conventional CPUs;

FIG. 13 is a schematic diagram illustrating the flow of a data transfer performed by the CPUs according to the first embodiment;

FIG. 14 is a schematic diagram illustrating the flow of a data transfer without using an H-CPU;

FIG. 15 is a timing chart illustrating the flow of the data transfer without using the H-CPU;

FIG. 16 is a schematic diagram illustrating the flow of data when the cache state is “I”;

FIG. 17 is a timing chart illustrating the flow of the data when the cache state is “I”;

FIG. 18 is a schematic diagram illustrating the flow of data in the event that requests cross each other when the cache state is “I”;

FIG. 19 is a timing chart illustrating the flow of the data in the event that requests cross each other when the cache state is “I”;

FIG. 20 is a schematic diagram illustrating the flow of the data in the event that requests cross each other when the cache state is “I”;

FIG. 21 is a flowchart illustrating the flow of a process performed by an L2 cache unit when it receives a request;

FIG. 22 is a schematic diagram illustrating a data transfer process performed among three conventional CPUs;

FIG. 23 is a timing chart illustrating the data transfer process performed among the three conventional CPUs;

FIG. 24 is a schematic diagram illustrating a process for directly transferring data to an L-CPU;

FIG. 25 is a timing chart illustrating the process for directly transferring the data to the L-CPU;

FIG. 26 is a schematic diagram illustrating a data transfer performed when an L-CPU and an R-CPU are the same; and

FIG. 27 is a timing chart illustrating the data transfer performed when the L-CPU and the R-CPU are the same.

### DESCRIPTION OF EMBODIMENTS

Preferred embodiments of the present invention will be explained with reference to accompanying drawings.

### [a] First Embodiment

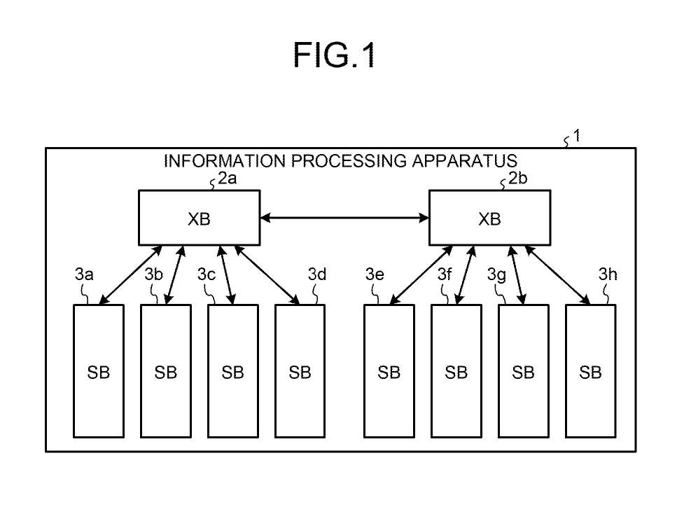

In the following, the configuration of an information processing apparatus according to a first embodiment will be described with reference to FIG. 1. FIG. 1 is a schematic diagram illustrating an example of the configuration of an information processing apparatus according to a first embodiment. As illustrated in FIG. 1, an information processing apparatus 1 according to the first embodiment includes crossbar switches (XBs) 2a and 2b and system boards (SBs) 3a to 3h. The number of crossbar switches and system boards illustrated in FIG. 1 is only an example and is not limited thereto.

The XB 2a dynamically selects a route for data exchanged among the SBs 3a to 3h and is a switch that functions as a data transfer unit that transfers data. Here, data includes a program or the arithmetic processing result. The configuration of the XB 2b is the same as that of the XB 2a; therefore, a description thereof in detail will be omitted. Furthermore, the SB 3a includes CPUs and memories and executes various kinds of arithmetic processing. The configuration of the SBs 3b to 3h is the same as that of the SB 3a; therefore, a description thereof in detail will be omitted.

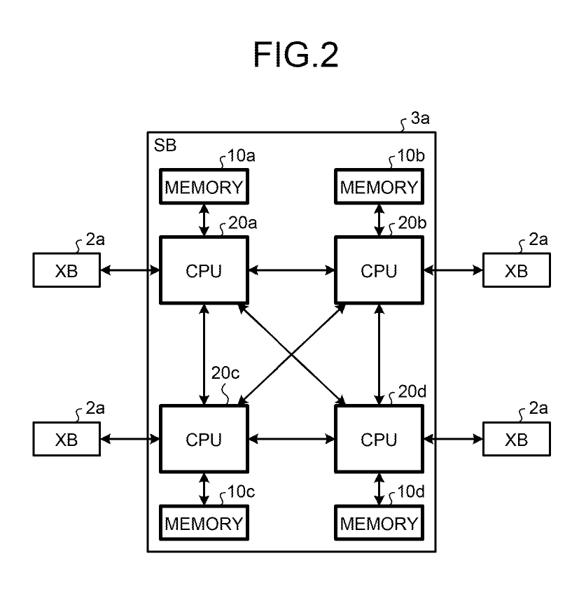

In the following, an example of the configuration of one of the SBs will be described with reference to FIG. 2. FIG. 2 is a schematic diagram illustrating an example of the configuration of an SB according to the first embodiment. In the example illustrated in FIG. 2, the SB 3a includes memories 10a to 10d, each of which functions as the main storage device, and includes CPUs 20a to 20d, each of which functions as a processor and is connected with each other. Specifically, the CPU 20a accesses the memory 10a and the CPU 20b accesses the memory 10b. Furthermore, the CPU 20c accesses the memory 10c and the CPU 20d accesses the memory 10d.

Furthermore, the CPUs 20a to 20d are connected to the memories 10a to 10d, respectively. It is assumed that the memories 10b to 10d have the same function as that performed by the memory 10a; therefore, a description thereof will be omitted. Furthermore, it is assumed that the CPUs 20b to 20d execute the same process as that executed by the CPU 20a; therefore, a description thereof will be omitted.

For example, the CPU 20a has a cache memory; holds, in the cache memory, the data stored in the memory 10a, which is the main memory managed by the CPU 20a; and executes various kinds of arithmetic processing on the held data. Furthermore, if the CPU 20a holds, in the cache memory, the data stored in one of the memories 10b to 10d, the CPU 20a issues, to one of the corresponding CPUs 20b to 20d, a request for a transfer of the data. Then, the CPU 20a receives data that is targeted by the request from corresponding one of the CPUs 20b to 20d that received the request and holds the received data in the cache memory. The CPUs 20a to 20d are connected to the XB 2a and thus they can also acquire data stored in a memory included in an SB 3 (not illustrated) that is connected to the XB 2b that is connected to the XB 2a.

In contrast, the memory 10a stores therein data that is used for arithmetic processing by each of the CPUs 20a to 20d. Furthermore, the memory 10a stores therein directory information indicating which CPU stores in its own cache memory the data that is stored in the memory 10a. For example, the CPU 20a sets, in the memory 10a, an area that stores therein various pieces of data and an area that stores therein directory information and associates the area that stores therein the various pieces of data with the area that stores therein the directory information. Then, the CPU 20a stores, in the area associated with the area that stores therein the various pieces of data, the state of the data and directory information that indicates the CPU that stores the data in its own cache memory.

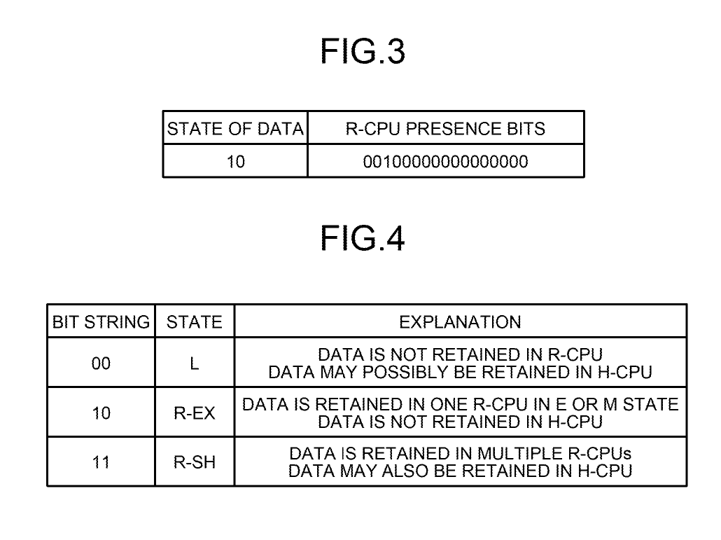

In the following, an example of directory information that is stored in the memory 10a by the CPU 20a will be described with reference to FIG. 3. FIG. 3 is a schematic diagram illustrating an example of directory information. As illustrated in FIG. 3, for various pieces of data, the CPU 20a stores the directory information in which the state of data is associated with R-CPU presence bits. The state of data mentioned here is a 2-bit bit string that indicates the state of data held in the cache memory.

FIG. 4 is a schematic diagram illustrating the directory status. FIG. 4 illustrates the status of a bit string that indicates the state of data. For example, the bit string “00” indicates the status “Local (L)”. The status “L” mentioned here is the state in which data is not held in a cache memory in another CPU, i.e., in an R-CPU, and may possibly be held in a cache memory in an H-CPU.

Furthermore, the bit string “10” indicates the status “Remote-Exclusive (R-EX)”. The status “R-EX” mentioned here is the state in which the cache state is “Exclusive (E)” or “Modified (M)”, where one R-CPU holds data in its own cache memory and an H-CPU does not hold data in its own cache memory.

The cache state mentioned here is information indicating the state of data held in a cache memory and takes one of “Invalid (I)”, “Shared (S)”, “E”, and “M”. “Invalid (I)” mentioned here indicates the state in which cache data is not registered; “Shared(S)” indicates the state in which another CPU also holds the same data in its own cache memory and the state is clean; “E” indicates the state in which data is exclusively held in a cache memory and the state is clean; and “M” indicates the state in which data is exclusively held in a cache memory and the state is dirty.

Furthermore, the bit string “11” indicates the status “Remote-Shared (R-SH)”. The status “R-SH” mentioned here is the state in which data may possibly be held in multiple cache memories in multiple R-CPUs and be held in a cache memory in an H-CPU.

A description will be given here by referring back to FIG. 3. The R-CPU presence bits mentioned here mean the bit string indicating which cache memory in a CPU stores data. For example, the CPU 20a associates bits of the bit string with CPUs included in the information processing apparatus 1 and sets a bit associated with a CPU that holds the data in the cache memory to “1”, thereby the CPU 20a identifies the bits of data held in a cache memory. However, the CPU 20a sets a bit associated with its own device, i.e., the CPU 20a, to “0”.

For example, as illustrated in FIG. 3, if the information processing apparatus 1 has 16 CPUs, the CPU 20a uses a bit string with 16 bits as the R-CPU presence bits. Consequently, the directory information illustrated in FIG. 3 as an example indicates the state “R-EX”, in which data with its cache state of “E” or “M” is held in a cache memory in a CPU that is associated with the 3^{rd} bit from the top in the CPU presence bits.

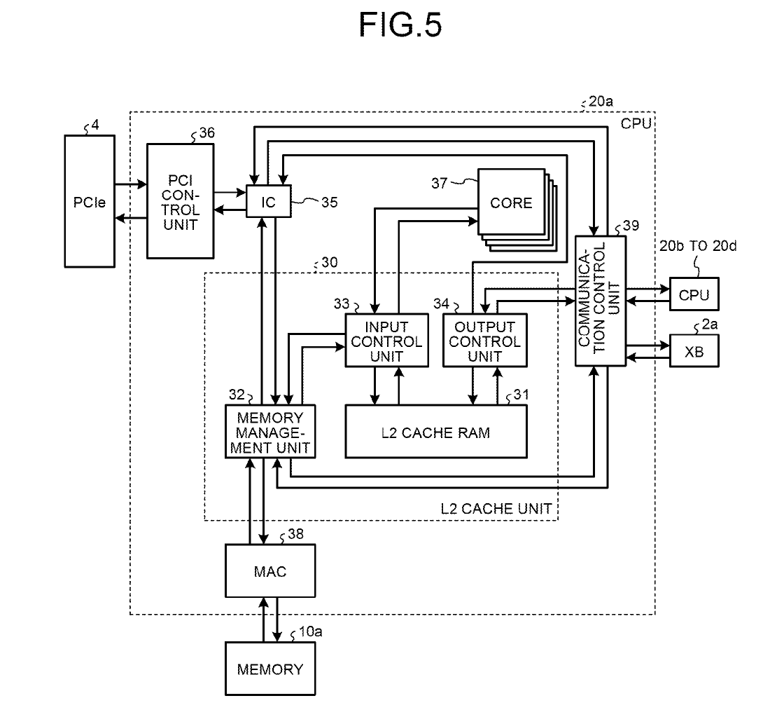

In the following, an example configuration of the CPU will be described with reference to FIG. 5. FIG. 5 is a schematic diagram illustrating an example of a CPU according to the first embodiment. In the example illustrated in FIG. 5, the CPU 20a includes an L2 cache unit 30, an IC 35, a PCI control unit 36, multiple cores 37, a memory access controller (MAC) 38, and a communication control unit 39. Furthermore, the L2 cache unit 30 includes an L2 cache random access memory (RAM) 31, a memory management unit 32, an input control unit 33, and an output control unit 34.

Furthermore, the CPU 20a is connected to various IO devices via a PCIe 4. If one of the various 10 devices requests data stored in the memory 10a, the CPU 20a acquires data from the memory 10a and outputs the data via the PCIe 4 to the IO device that requested the data. Furthermore, the CPU 20a is connected to each of the CPUs 20b to 20d and transmits and receives various kinds of data or messages to/from CPUs 20b to 20d. And CPU 20a transmits and receives, via the XB 2a and the XB 2b, to/from a CPU included in one of the SBs 3b to 3h.

Furthermore, the CPU 20a has a route, between the output control unit 34 and the IC 35, for transmitting and receiving data that is read from the L2 cache RAM 31. Specifically, the CPU 20a has a route for directly transmitting the data held in the L2 cache unit 30 from the L2 cache unit 30 to the IC 35.

In the following, the function performed by the L2 cache unit 30 will be described. The L2 cache RAM 31 is a cache memory that holds therein data stored in each of the memories 10a to 10d. For example, if the L2 cache RAM 31 receives a memory address from the input control unit 33 or the output control unit 34, the L2 cache RAM 31 outputs the data stored in the received memory address to the input control unit 33 or to the output control unit 34. Furthermore, the L2 cache RAM 31 may also use a cache line technology for storing data for each index address, which is an upper address of a memory address, or may also have multiple ways in each cache line.

The memory management unit 32 controls input-output processing of data stored in the memory 10a. Furthermore, by using the directory information stored in the memory 10a, the memory management unit 32 holds the coherency between the data in the memory 10a and the data held in a cache memory from the memory 10a by each of the CPUs 20b to 20d and the CPUs that are included in the SBs 3b to 3h.

For example, if the memory management unit 32 receives a data acquisition request issued by the IC 35 due to an IO device requesting a transfer of data, the memory management unit 32 accesses the memory 10a via the MAC 38 to acquire data targeted by the data acquisition request. Then, the memory management unit 32 outputs the acquired data to the IC 35.

Furthermore, if the memory management unit 32 receives, from the input control unit 33, an acquisition request for the data held in the L2 cache RAM 31, the memory management unit 32 performs the memory access via the MAC 38 and outputs the data acquired from the memory 10a to the input control unit 33.

Furthermore, the memory management unit 32 receives, via the communication control unit 39, an IO request issued by one of the CPUs 20b to 20d included in the SB 3a or one of the CPUs 20b to 20d included in one of the SBs 3b to 3h (hereinafter, referred to as the other different CPUs 20b to 20d). The IO request mentioned here is a transfer request for data issued to an H-CPU when one of the other different CPUs 20b to 20d receives an acquisition request for the data stored in the memory 10a from an IO device.

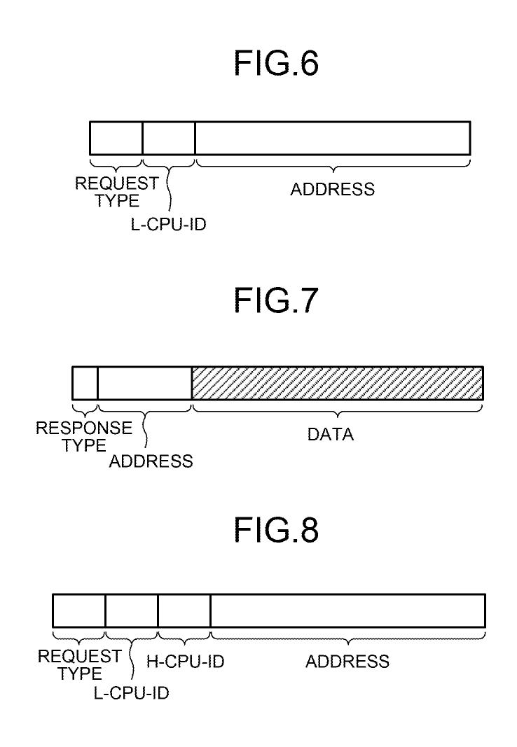

In the following, an example of an IO request will be described with reference to FIG. 6. FIG. 6 is a schematic diagram illustrating an example of an IO request. As illustrated in FIG. 6, the IO request stores therein a request type, an L-CPU-ID, and an address. The request type mentioned here is information indicating the content of a process performed on the data and is an operation code. The L-CPU-ID mentioned here is an identifier indicating an issue source CPU of an IO request, i.e., an L-CPU. The address mentioned here is a memory address that stores therein transfer target data.

A description will be given here by referring back to FIG. 5. If the memory management unit 32 receives an IO request, the memory management unit 32 accesses the memory 10a via the MAC 38 and acquires transfer target data and directory information. Then, if the acquired directory information is “L” or “R-SH”, the memory management unit 32 performs the following process. Namely, first, the memory management unit 32 determines whether the transfer target data is held in the L2 cache RAM 31.

If the transfer target data is not held in the L2 cache RAM 31, i.e., if the cache state is “I”, the memory management unit 32 stores, in an IO response that is a response to the IO request, the transfer target data acquired from the memory. Furthermore, if the transfer target data is “E” and if the data is held in the L2 cache RAM 31, the memory management unit 32 stores, in an IO response, the transfer target data acquired from the memory.

Furthermore, if the cache state is “M” and if the data is held in the L2 cache RAM 31, the memory management unit 32 performs a write back process on the data held in the L2 cache RAM 31 and updates the data in the memory 10a. Then, the memory management unit 32 stores the updated data in the IO response. Thereafter, the memory management unit 32 transmits the IO response to one of the other different CPUs 20b to 20d, which is the issue source of the IO request, via the communication control unit 39.

FIG. 7 is a schematic diagram illustrating an example of an IO response. As illustrated in FIG. 7, the response stores therein a response type, an address, and data. The response type mentioned here is an operation code indicating the content of a response. The address mentioned here is a memory address that stores therein transfer target data. The data mentioned here is transfer target data.

If the acquired directory information is “R-EX”, the memory management unit 32 performs the following process. Namely, first, the memory management unit 32 transmits an IO response that does not store therein data to one of the other different CPUs 20b to 20d, i.e., the issue source of the IO request. Furthermore, the memory management unit 32 identifies, by using the R-CPU reference bit, an R-CPU that holds the transfer target data. Then, the memory management unit 32 creates the data transfer request illustrated in FIG. 8 and transmits the data transfer request to the identified R-CPU via the communication control unit 39.

FIG. 8 is a schematic diagram illustrating an example of a data transfer request. In the example illustrated in FIG. 8, the data transfer request stores therein a request type, an L-CPU-ID, an H-CPU-ID, and an address. The H-CPU-ID mentioned here is an identifier indicating an H-CPU. For example, the CPU 20a receives, from the CPU 20c, an IO request for the data that is held by the CPU 20b from the memory 10b. In such a case, the CPU 20a sets the identifier of the CPU 20b to an L-CPU-ID and transmits a data transfer request, in which the identifier of the CPU 20a is an H-CPU-ID, to the CPU 20c that is an R-CPU.

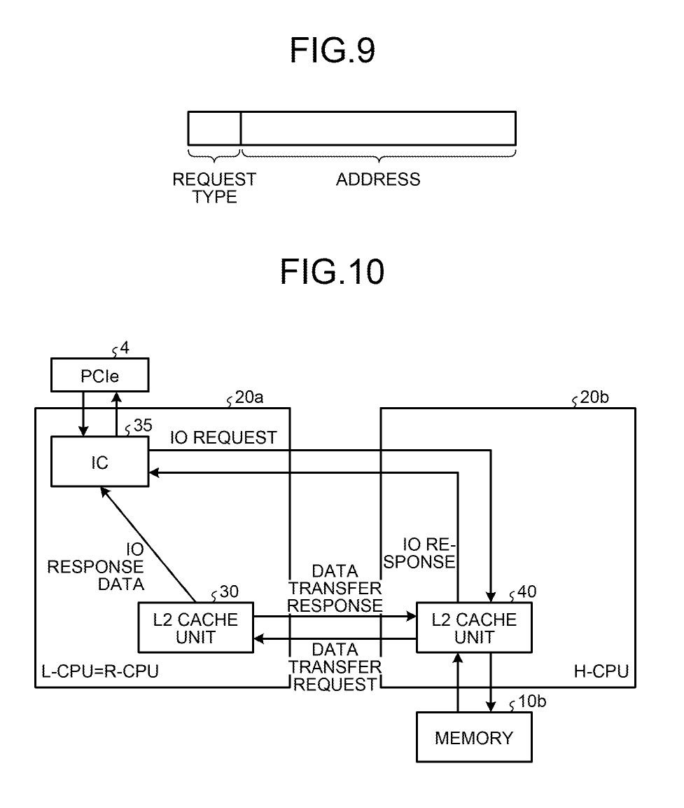

Furthermore, as a response to the data transfer request from the R-CPU that has transmitted the data transfer request, the memory management unit 32 receives the data transfer response illustrated in FIG. 9. FIG. 9 is a schematic diagram illustrating an example of a data transfer response. As illustrated in FIG. 9, the data transfer response stores therein a request type and an address. The address of the data transfer response is the same address that is held in the data transfer request resulting in the data transfer response, i.e., the same address that stores therein the transfer target data.

Furthermore, when the memory management unit 32 receives an IO request, similarly to the conventionally performed process, after the memory management unit 32 receives the data transfer response without transmitting an IO response, the memory management unit 32 may also transmit an IO response that does not store therein data to one of the other different CPUs 20b to 20d, i.e., the issue source of the IO request.

Furthermore, similarly to the conventionally performed process, if the core 37 issues a command for requesting data in a memory managed by one of the other different CPUs 20b to 20d, the memory management unit 32 issues a request for transferring the data to an H-CPU. Then, if the memory management unit 32 receives data and a request response from the H-CPU or the R-CPU, the memory management unit 32 outputs the data to the input control unit 33. Furthermore, if the memory management unit 32 transmits the data stored in the memory 10a to one of the other different CPUs 20b to 20d or if the memory management unit 32 updates the data in the memory 10a by using the write back process, the memory management unit 32 updates the directory information every time such a transmission or update occurs.

A description will be given here by referring back to FIG. 5. If the input control unit 33 receives a command for requesting the reading or writing of data from the core 37, the input control unit 33 outputs, to the L2 cache RAM 31, a memory address that is targeted by the command. Then, the input control unit 33 outputs the acquired data to the core 37 that is the issue source of the command. Furthermore, if the data targeted by the command is not held in the L2 cache RAM 31 and thus a cache miss occurs, the input control unit 33 issues an acquisition request for data to the memory management unit 32.

Then, if the input control unit 33 receives the data from the memory management unit 32, the input control unit 33 stores the received data in the L2 cache RAM 31 and outputs again the memory address to the L2 cache RAM 31 to acquire the data. Thereafter, the input control unit 33 outputs the acquired data to the core 37 that is the issue source of the command. If the input control unit 33 writes back the data stored in the L2 cache RAM 31, the input control unit 33 outputs the data acquired from the L2 cache RAM 31 to the memory management unit 32.

If the output control unit 34 receives a data transfer request that has been issued by one of the other different CPUs 20b to 20d via the communication control unit 39, the output control unit 34 outputs the address included in the data transfer request to the L2 cache RAM 31 and acquires the transfer target data. Then, the output control unit 34 creates an IO response that stores therein the acquired data.

Furthermore, the output control unit 34 extracts an L-CPU-ID from the data transfer request and determines whether the extracted L-CPU-ID has the same ID as that of the CPU 20a. Specifically, the output control unit 34 determines whether the L-CPU that has issued an IO request to an H-CPU and an R-CPU that holds transfer target data received from the H-CPU are the same.

If the output control unit 34 determines that the L-CPU-ID extracted from the data transfer request has the same ID as that of the CPU 20a, the output control unit 34 directly outputs the created IO response to the IC 35. In contrast, if the L-CPU-ID is different from the ID of the CPU 20a, the output control unit 34 transmits the created IO response to a CPU indicated by the L-CPU-ID via the communication control unit 39. Furthermore, if the output control unit 34 transmits an IO response to the IC 35 or one of the other different CPUs 20b to 20d, the output control unit 34 creates a data transfer response and transmits the created data transfer response to an H-CPU that is the transmission source of the data transfer request.

The IC 35 controls, via the PCI control unit 36 and the PCIe 4, an IO process performed in the CPU 20a. Specifically, the IC 35 controls a data acquisition process with respect to the various 10 devices. For example, if the IC 35 receives a data acquisition request from the PCIe 4 via the PCI control unit 36, the IC 35 determines whether the memory address that stores therein acquisition target data is the memory address of the memory 10a. If the memory address that stores therein acquisition target data is the memory address of the memory 10a, the IC 35 requests acquisition of the data from the memory management unit 32.

In contrast, if the memory address that stores therein acquisition target data is not the memory address of the memory 10a, the IC 35 creates an IO request that includes the memory address that stores therein the acquisition target data. Then, the IC 35 outputs the created IO request to the communication control unit 39.

Furthermore, if the IC 35 receives an IO response from the communication control unit 39 or from the output control unit 34, the IC 35 extracts data from the IO response and outputs the extracted data to the PCIe 4 via the PCI control unit 36. If the IC 35 receives only an IO response that does not store data therein, the IC 35 does not end the IO process, whereas the IC 35 ends the IO process if the IC 35 receives an IO response that stores data therein. Furthermore, if the IC 35 acquires data from the memory management unit 32, the IC 35 outputs the acquired data to the PCIe 4 via the PCI control unit 36 and ends the process.

The PCI control unit 36 is an interface between the PCIe 4 and the CPU 20a and converts signals of the PCIe 4 and internal signals of the CPU 20a. For example, the PCI control unit 36 performs interconversion between serial data in the PCIe 4 and parallel data inside the CPU 20a or performs various communication controls of the PCIe 4.

The multiple cores 37 are processor cores that execute various kinds of arithmetic processing by using various pieces of data held in the L2 cache RAM 31 in the L2 cache unit 30. For example, one of the cores 37 issues a command to the L2 cache unit 30 to acquire data and executes the arithmetic processing by using the acquired data. Each of the multiple cores 37 may also have an L1 cache that holds the data held by the L2 cache unit 30.

The MAC 38 is a memory access controller that controls memory access with respect to the memory 10a. For example, the MAC 38 accesses the memory 10a, extracts the data stored in the memory address that has been issued by the L2 cache unit 30, and outputs the extracted data to the L2 cache unit 30.

The communication control unit 39 controls communication between the CPU 20a and the CPUs 20b to 20d via the XB 2a. Furthermore, the communication control unit 39 controls communication between the CPU 20a and the CPUs 20b to 20d that are included in the SB 3a. For example, if the communication control unit 39 receives, from a coherent control unit 25, various messages, such as a request, a request response, a data transfer request, a data transfer response, an IO request, an IO response, and the like, that are transmitted and received among the CPUs, the communication control unit 39 determines which CPU corresponds to the destination of which of the received messages.

Then, in accordance with which of the CPUs corresponds to the destination of which of the messages, the communication control unit 39 outputs the various messages to their appropriate destinations, which are CPUs 20b to 20d or the XB 2a. Specifically, if the communication control unit 39 receives various messages as parallel data from the coherent control unit 25, the communication control unit 39 converts the received messages to serial data and transmits the converted serial data via multiple lanes. Furthermore, if the communication control unit 39 receives various messages from the other different CPUs 20b to 20d or the XB 2a, the communication control unit 39 transmits the received messages to the coherent control unit 25.

For the process performed by the communication control unit 39 for identifying a CPU that is the destination of a message, an arbitrary method can be conceived as follows. First, the information processing apparatus 1 maps the same memory address space in all of the memories. The communication control unit 39 has a table in which each memory address is associated with an identifier of a CPU that manages the memory having the mapped memory address. Then, the communication control unit 39 determines, from the table, a CPU that is associated with the memory address to be processed depending on the various messages.

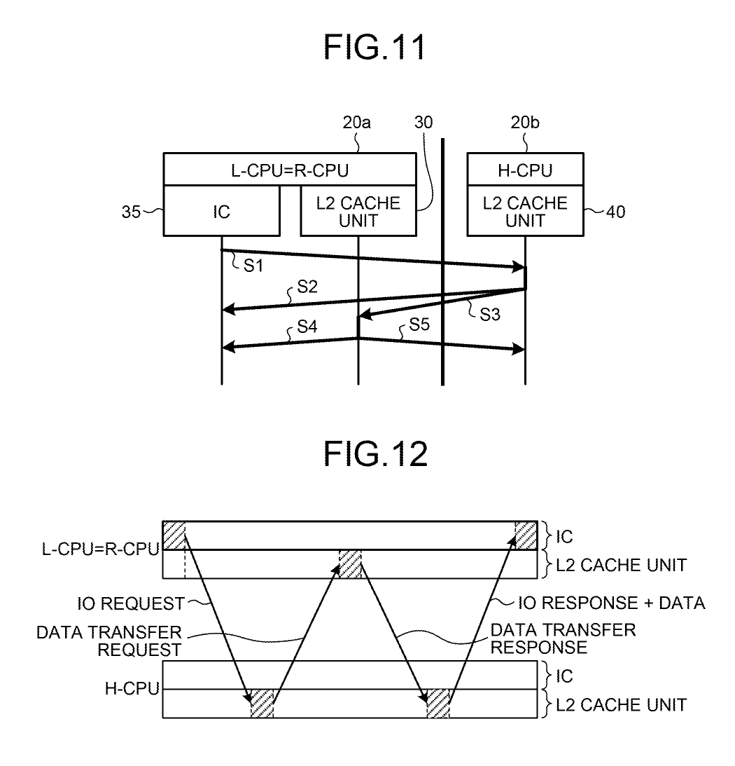

In the following, the flow of a data transfer performed when the CPU 20a functions as an L-CPU and an R-CPU will be described with reference to FIG. 10. FIG. 10 is a schematic diagram illustrating the flow of a data transfer performed by CPUs according to the first embodiment. In the example illustrated in FIGS. 10 and 11, the CPU 20a is an L-CPU that issues an IO request to the CPU 20b, which is an H-CPU, and is also an R-CPU that holds data therein from the memory 10b managed by the CPU 20b.

Furthermore, it is assumed that the CPU 20a has updated the data held from the memory 10b. Furthermore, it is assumed that the CPU 20b includes an L2 cache unit 40 that has the same function as that performed by the L2 cache unit 30 in the CPU 20a.

For example, if the IC 35 in the CPU 20a receives, from the PCIe 4, an acquisition request for the data in the memory 10b, the IC 35 outputs an IO request to the L2 cache unit 40 in the CPU 20b. Then, the L2 cache unit 40 accesses the memory 10b and determines that the directory state is “R-EX”. Then, the L2 cache unit 40 transmits a data transfer request to the L2 cache unit 30 in the CPU 20a that is an R-CPU.

Then, the L2 cache unit 30 determines whether the L-CPU-ID stored in the data transfer request is the same ID as that of the CPU 20a. If the IDs are the same, the L2 cache unit 30 outputs an IO response that stores the data therein to the IC 35 in the CPU 20a. Furthermore, the L2 cache unit 30 transmits a data transfer response to the L2 cache unit 40 in the CPU 20b. Then, the L2 cache unit 40 transmits, to the IC 35, an IO response that does not store the data therein and ends the process.

In the following, the timing with which the CPU 20a and the CPU 20b transfer data will be described with reference to FIG. 11. FIG. 11 is a timing chart illustrating the flow of the data transfer performed by the CPUs according to the first embodiment. For example, the IC 35 issues an IO request to the L2 cache unit 40 in the CPU 20b (Step S1). Then, the L2 cache unit 40 transmits an IO response that does not store data therein to the IC 35 (Step S2) and issues a data transfer request to the L2 cache unit 30 in the CPU 20a (Step S3).

Then, if the L2 cache unit 30 determines that the L-CPU that is the transfer destination of the data is the CPU 20a that is an R-CPU, the L2 cache unit 30 outputs an IO request that stores the data therein to the IC 35 (Step S4). Furthermore, the L2 cache unit 30 issues a data transfer response to the L2 cache unit 40 in the CPU 20b (Step S5) and ends the process.

As described above, when the CPU 20a receives, as an R-CPU, a data transfer request, if the CPU 20a is an L-CPU, the CPU 20a allows the L2 cache unit 30 to output the data and an IO response to the IC 35. Consequently, the IC 35 can receive both the IO response and the data during a transfer performed between the CPUs twice. Thus, the CPU 20a can improve the efficiency of the data transfer.

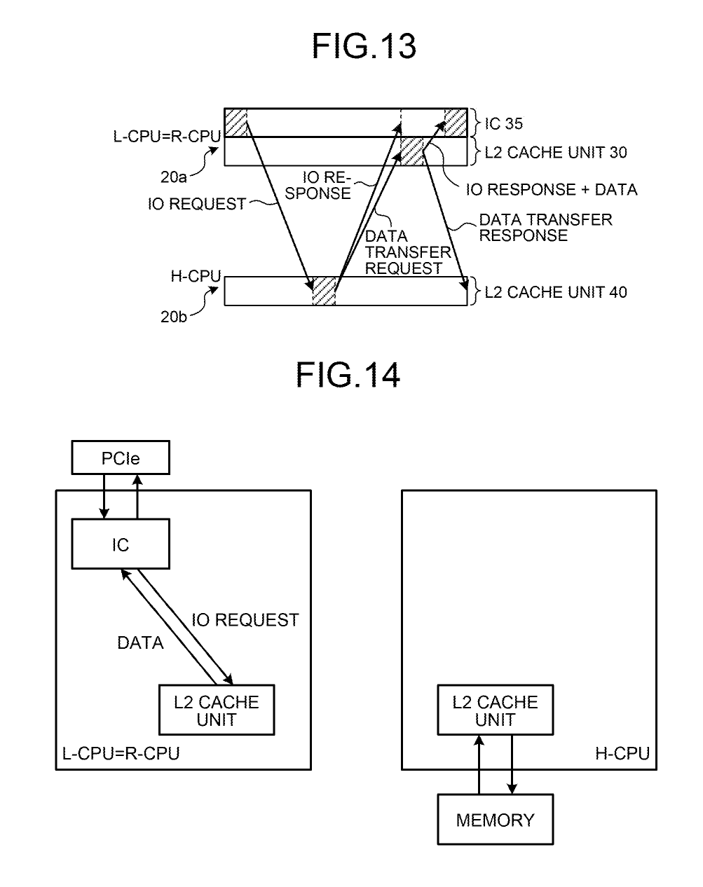

In the following, how the CPU 20a improves the efficiency of a data transfer will be described with reference to FIGS. 12 and 13. First, the time taken for a data transfer by a conventional CPU to transfer data when an R-CPU and an L-CPU are the same CPU will be described with reference to FIG. 12. FIG. 12 is a schematic diagram illustrating the flow of a data transfer performed by conventional CPUs. FIG. 12 illustrates a data transfer executed by a conventional CPU when an L-CPU and an R-CPU are the same CPUs.

For example, a conventional L-CPU=R-CPU transmits an IO request to an H-CPU. Then, the conventional H-CPU transmits a data transfer request to the L-CPU=R-CPU. Here, because the conventional L-CPU=R-CPU does not have a route through which data is transmitted and received between an IC and an L2 cache unit, the conventional L-CPU=R-CPU transmits a data transfer response that stores data therein to the H-CPU.

The conventional H-CPU transmits data and an IO response to the L-CPU=R-CPU. As described above, with conventional CPUs, if an L-CPU and an R-CPU are the same CPU, because communication between the CPUs is performed four times from when the L-CPU issues an IO request until the L-CPU receives the data, the efficiency of the data transfer is degraded.

In contrast, FIG. 13 is a schematic diagram illustrating the flow of a data transfer performed by the CPUs according to the first embodiment. As illustrated in FIG. 13, the CPU 20b that also functions as an H-CPU is represented by the H-CPU 20b. And illustrated in FIG. 13, the IC 35 in the CPU 20a transmits an IO request to the L2 cache unit 40 in the H-CPU 20b. Then, the L2 cache unit 40 transmits an IO response that does not store data therein to the IC 35 and issues a data transfer request to the L2 cache unit 30 in the CPU 20a. Consequently, the L2 cache unit 30 outputs both an IO response and the data to the IC 35 and transmits a data transfer response to the L2 cache unit 40.

As described above, when the CPU 20a receives the data transfer request, the CPU 20a determines whether an L-CPU is the CPU 20a. If the L-CPU is the CPU 20a, the CPU 20a allows the L2 cache unit 30 to output both the IO response and the data to the IC 35. Consequently, because the CPU 20a can receive the data when the communication between the CPUs is performed only twice after the CPU 20a issues an IO request, the efficiency of the data transfer can be improved.

Furthermore, if the CPU 20a determines that an L-CPU is not the CPU 20a, the CPU 20a transmits an IO response that stores the data therein to the IC in the R-CPU. Consequently, similarly to the conventionally performed process, the CPU 20a can transfer the data during the communication between the CPUs three times even if the L-CPU and the R-CPU are different.

Furthermore, instead of determining whether the CPU 20a holds data when the CPU 20a issues, as an L-CPU, an IO request, the CPU 20a determines whether the CPU 20a is an L-CPU when the CPU 20a receives, as an R-CPU, a data transfer request from the H-CPU. Specifically, the CPU 20a transmits an IO request to the H-CPU once. Consequently, the CPU 20a can simplify the logic of the process performed by each of the CPUs 20a to 20d.

In the following, how the logic of the process is simplified due to the CPU 20a transmitting an IO request to an H-CPU will be described with reference to FIGS. 14 to 17. First, a problem occurring in a case in which an R-CPU, which also functions as an L-CPU, executes a process without using an H-CPU will be described with reference to FIGS. 14 to 16. FIG. 14 is a schematic diagram illustrating the flow of a data transfer without using an H-CPU.

For example, as illustrated in FIG. 14, if there is a route for transmitting and receiving data between the IC and the L2 cache unit, it is conceivable to use a method for outputting an IO request from the IC to the L2 cache unit and for outputting data from the L2 cache unit to the IC. However, if an IO request is not issued to the H-CPU, the transfer process is completed only inside the L-CPU and therefore it is not possible to perform a process on the basis of the directory information. Accordingly, it is conceivable to use a process performed on the basis of the cache state of the transfer target.

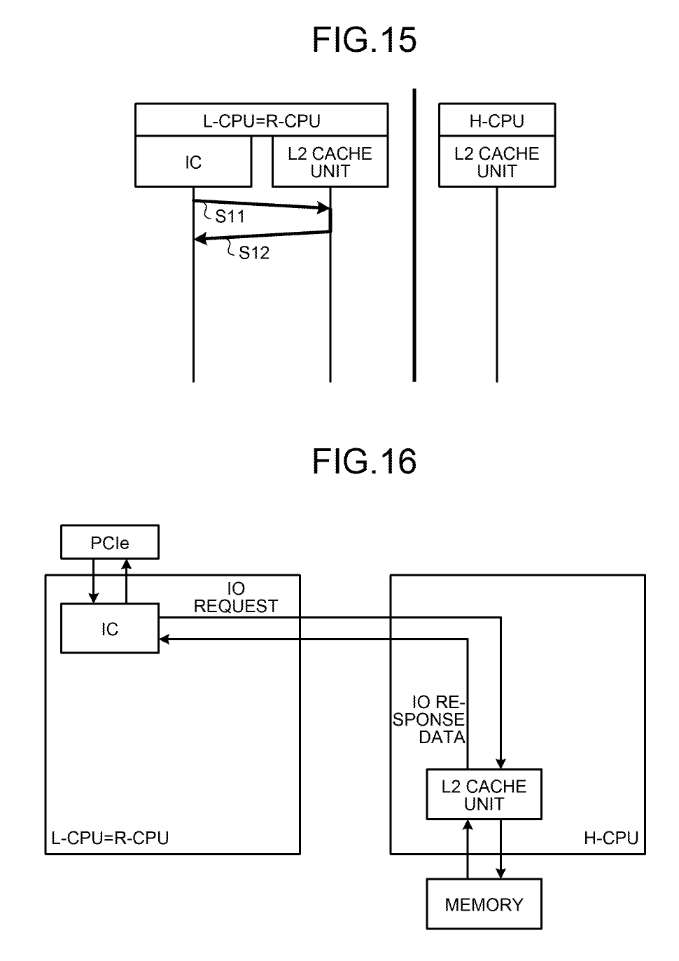

FIG. 15 is a timing chart illustrating the flow of the data transfer without using the H-CPU. As illustrated in FIG. 15, if the IC does not issue an IO request to the H-CPU, the IC issues the IO request to the L2 cache unit (Step S11). If the cache state of the transfer target data is “E”, “M”, or “S”, the L2 cache unit outputs the data to the IC because the data is held. (Step S12).

However, if the cache state of the transfer target data is “I”, the L2 cache unit is not able to output the data to the IC. Consequently, as illustrated in FIG. 16, if the IO request with respect to the L2 cache unit is not completed due to a cache miss, the IC transmits the IO request to the L2 cache unit in the H-CPU.

FIG. 16 is a schematic diagram illustrating the flow of data when the cache state is “I”. For example, if the cache state is “I”, the L-CPU=R-CPU transmits an IO request to the L2 cache unit in the H-CPU. Then, the L2 cache unit in the H-CPU checks the directory information stored in the memory. If the directory information is “L”, the L2 cache unit transmits an IO response and the data to the IC. If the directory information is “R-EX” or “R-SH”, the L2 cache unit in the H-CPU transmits a data transfer request to the R-CPU.

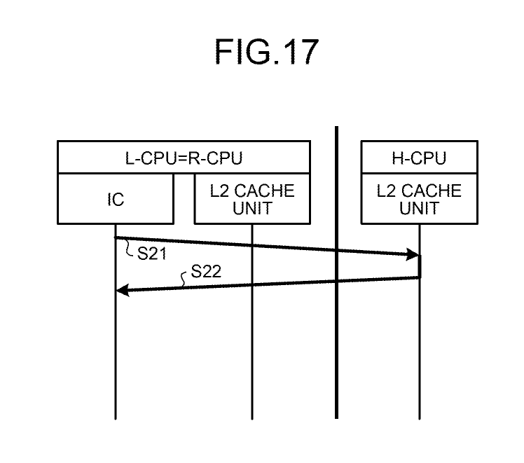

FIG. 17 is a timing chart illustrating the flow of the data when the cache state is “I”. For example, if a cache miss occurs, the IC in the L-CPU=R-CPU transmits an IO request to the L2 cache unit in the H-CPU (Step S21).

Then, the L2 cache unit in the H-CPU transmits an IO response and data to the IC in the L-CPU=R-CPU (Step S22).

As described above, even if a route for transferring data is present between the IC and the L2 cache unit, if the IC in the L-CPU=R-CPU does not transmit an IO request to the H-CPU, the IC needs to perform a process for changing the issue destination of the IO request depending on the cache state. Furthermore, in the H-CPU that has received the IO request, there is a need for branching of a process in accordance with the directory information. Consequently, processes performed by CPUs become complicated.

However, the CPU 20a according to the first embodiment transmits an IO request once to the L2 cache unit 40 in the H-CPU regardless of whether the CPU 20a is the R-CPU. Consequently, the CPU 20a needs to take into consideration only the branching in accordance with the directory information in the L2 cache unit 40. Consequently, with the CPU 20a, the process to be executed is simple and thus it is easy to design or test the circuit.

The process that transmits, by the L2 cache unit 40 in the H-CPU, a data transfer request to the R-CPU in accordance with the directory information is conventionally performed. Accordingly, when the CPU 20a receives, as a R-CPU, a data transfer request, if the CPU 20a performs a process for determining whether the CPU 20a is an L-CPU, it is possible to use the process performed by the H-CPU without changing anything, thus improving the transfer performance of data.

Furthermore, because the CPU 20a transmits an IO request to the L2 cache unit 40 in the H-CPU, if a case of crossing occurs in which the IC 35 and the core 37 both request the data in the same memory address, a data transfer can be appropriately performed without taking into consideration branching of the process to be performed. In the following, a description will be given of a process performed by the CPU 20a when a crossing occurs.

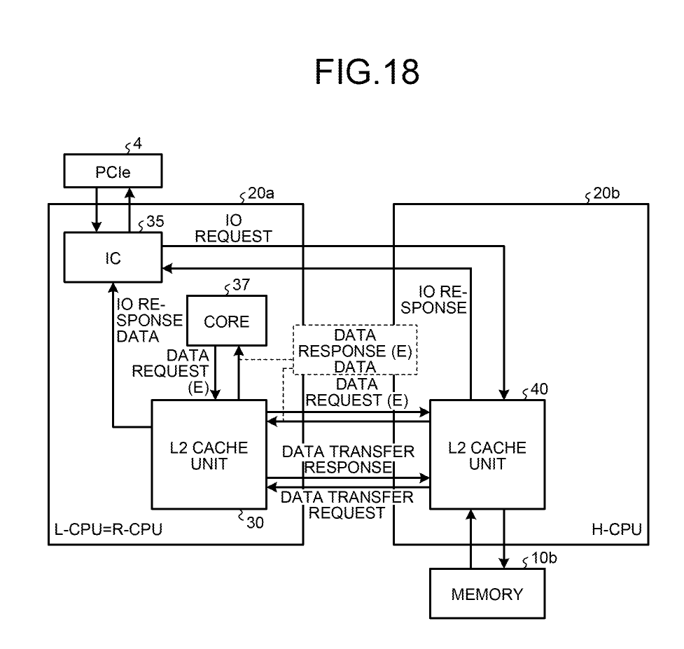

FIG. 18 is a schematic diagram illustrating the flow of data in the event that requests cross each other when the cache state is “I”. For example, because the core 37 holds data exclusively, the core 37 issues, to the L2 cache unit 30, a data request (E) for a transfer of data that is in the cache state of “E”.

Then, the L2 cache unit 30 issues the data request (E) to the L2 cache unit 40. Then, the L2 cache unit 40 transmits a data response (E) and the data to the L2 cache unit 30. Then, the L2 cache unit 30 transmits the data response (E) and the data to the core 37.

At this point, if the core 37 issues the data request (E) in a middle of the IO process, the cache state in the L2 cache unit 30 is changed. Consequently, with a conventional L-CPU=R-CPU, branching of the process occurs if the cache state of the data in the L-CPU is changed in the middle of an IO process.

However, the IC 35 according to the first embodiment issues an IO request to the L2 cache unit 40 in the CPU 20b that is an H-CPU. Then, even if a crossing process occurs, the L2 cache unit 40 can perform the operation in accordance with a change in the state due to the data request (E) issued by the core 37. Consequently, by outputting the IO request to the L2 cache unit 40 in the H-CPU, the CPU 20a can implement the data transfer process in accordance with the cache state without taking into consideration the crossing process.

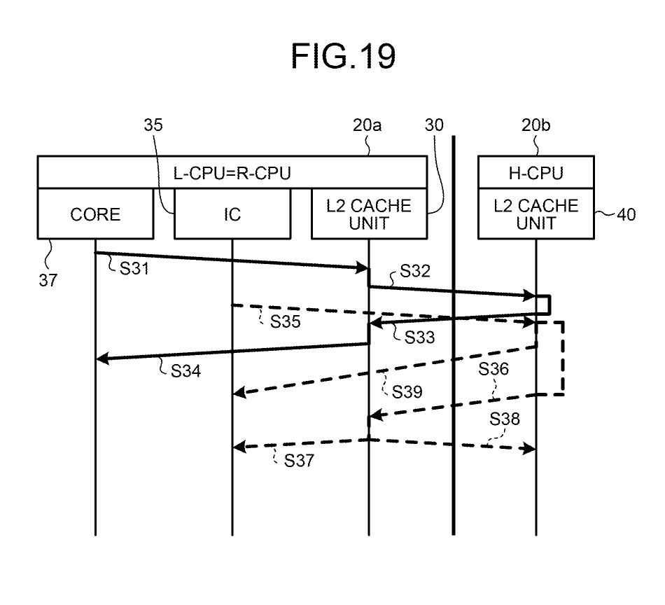

In the following, the flow of a process performed by the CPU 20a when a crossing process occurs will be described with reference to FIG. 19. FIG. 19 is a timing chart illustrating the flow of the data in the event that requests cross each other when the cache state is “I”. For example, the core 37 issues the data request (E) to the L2 cache unit 30 (Step S31).

Then, the L2 cache unit 30 transmits the data request (E) to the L2 cache unit 40 in the CPU 20b that functions as the H-CPU (Step S32). Then, the L2 cache unit 40 issues the data response (E) to the CPU 20a that functions as the L-CPU=R-CPU. Then, the L2 cache unit 30 outputs the data response (E) and the data to the core 37.

At this point, if the IC 35 receives an acquisition request for the data from the IO device after the L2 cache unit 30 issues the data request (E), the IC 35 transmits the IO request to the L2 cache unit 40 because the cache state of the data is “I”. Then, the L2 cache unit 40 determines that the CPU 20a is an R-CPU and then issues a data transfer request to the L2 cache unit 30.

Then, the L2 cache unit 30 determines that the CPU 20a is an L-CPU, outputs the data and an IO response to the IC 35 (Step S37), transmits a data transfer response to the L2 cache unit 40 (Step S38), and ends the process. If the L2 cache unit 40 receives a data transfer request, the L2 cache unit 40 transmits an IO response that does not store the data therein to the IC 35 (Step S39); however, this process may also be performed after a data transfer response is received.

At this point, as illustrated by the arrows indicated by the straight line and the dotted line in FIG. 19, for the processes at Steps S31 to S34 for the data request (E) and the processes at Steps S35 to S39 for the request, the same process as that performed when a crossing does not occur is performed in parallel. Accordingly, the CPU 20a can implement both a process for a data request and a process for an IO request by performing the usual data transfer process without taking into consideration the crossing process. Consequently, it is possible to simplify the design of the CPU 20a.

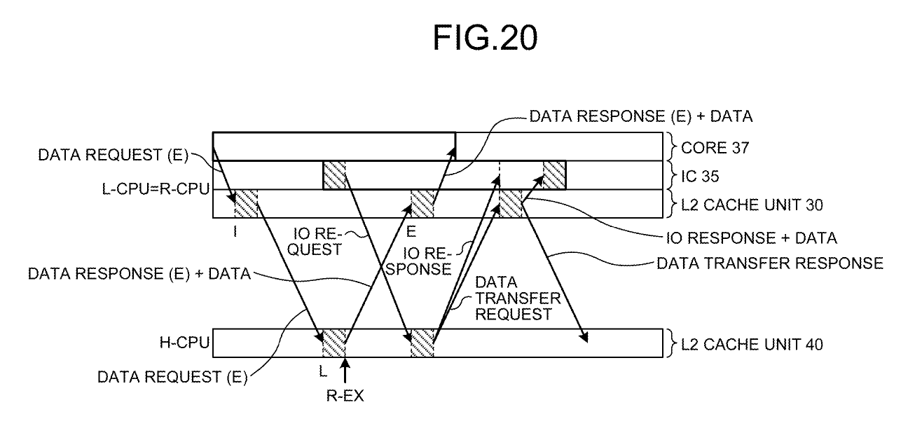

In the following, a shift of the cache state of an H-CPU will be described with reference to FIG. 20. FIG. 20 is a schematic diagram illustrating the flow of the data in the event that requests cross each other when the cache state is “I”. For example, as illustrated in FIG. 20, the core 37 in the L-CPU=R-CPU issues the data request (E).

Then, because the cache state is “I”, the L2 cache unit 30 issues the data request (E). Then, the L2 cache unit 40 updates the directory state from “L” to “R-EX” and transmits the data response (E) and the data to the L2 cache unit 30. Then, the L2 cache unit 30 holds the data as the cache state of “E” and outputs the data response (E) and the data to the core 37.

At this point, the IC 35 issues an IO request to the L2 cache unit 40 before the L2 cache unit 30 holds the data response (E) therein and without determining whether the CPU 20a holds the data therein. Then, because the directory state is “R-EX”, the L2 cache unit 40 outputs a data transfer request to the L2 cache unit 30 and outputs an IO response that does not store the data therein to the IC 35.

At this point, the L2 cache unit 30 determines, for the first time, whether the CPU 20a is an L-CPU. If it is determined that the CPU 20a is an L-CPU, the L2 cache unit 30 outputs the IO response and the data to the IC 35. Consequently, because the CPU 20a does not need to take into consideration the crossing process, the design of the CPUs can be simplified.

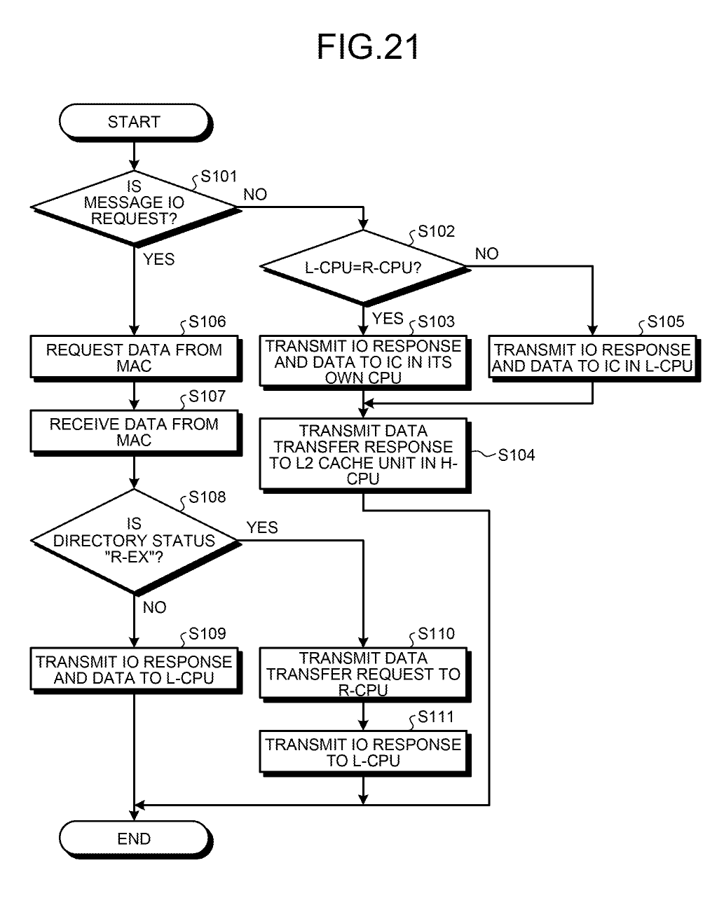

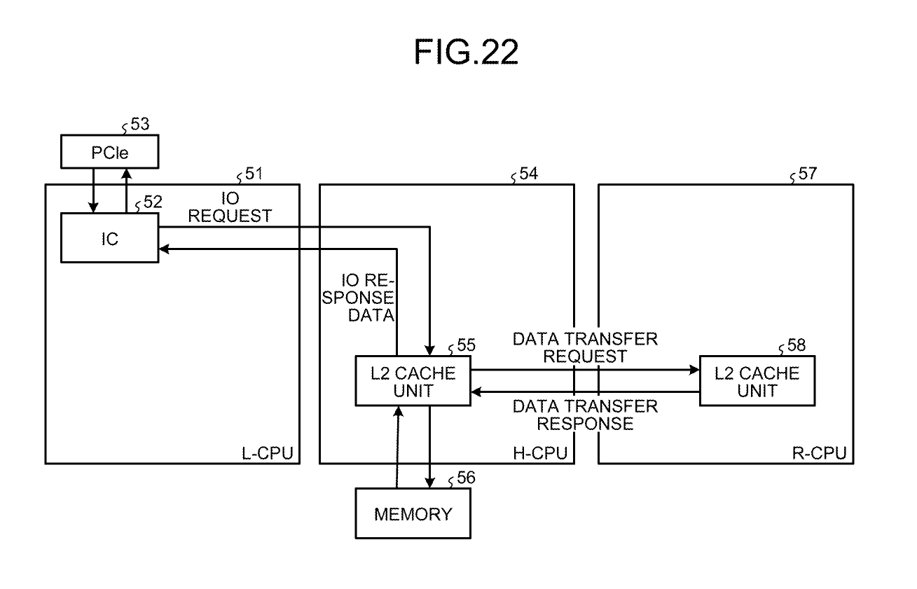

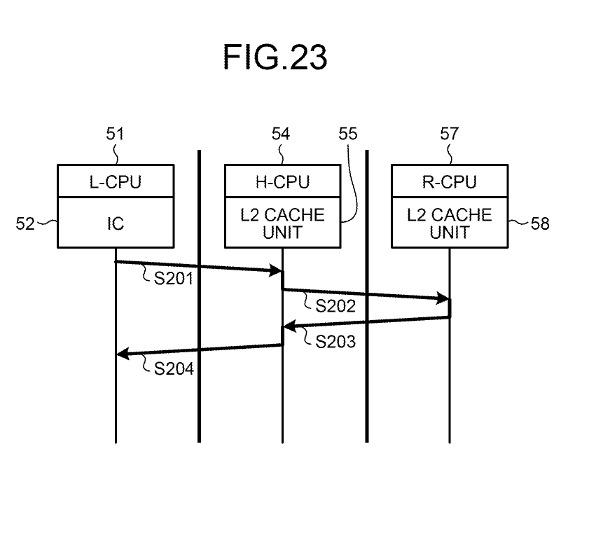

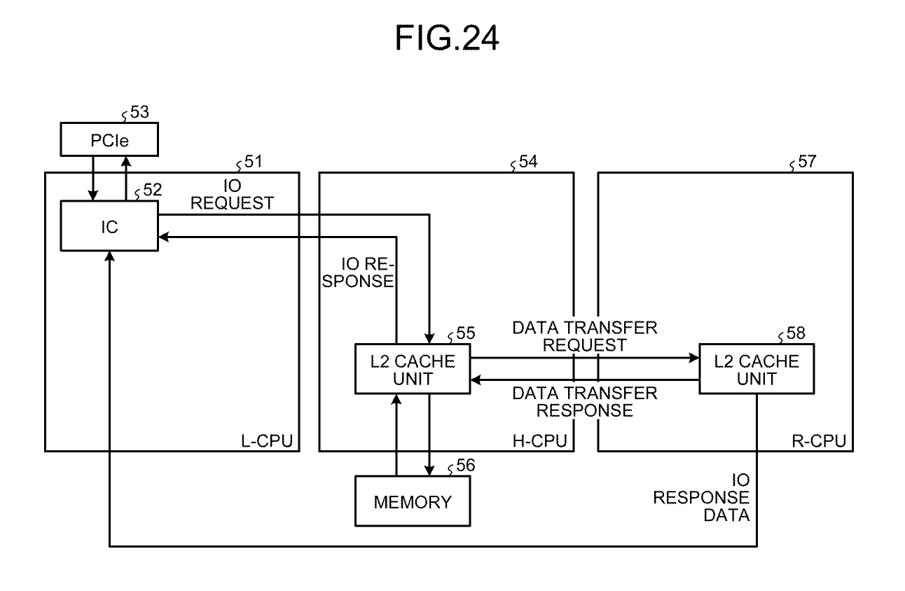

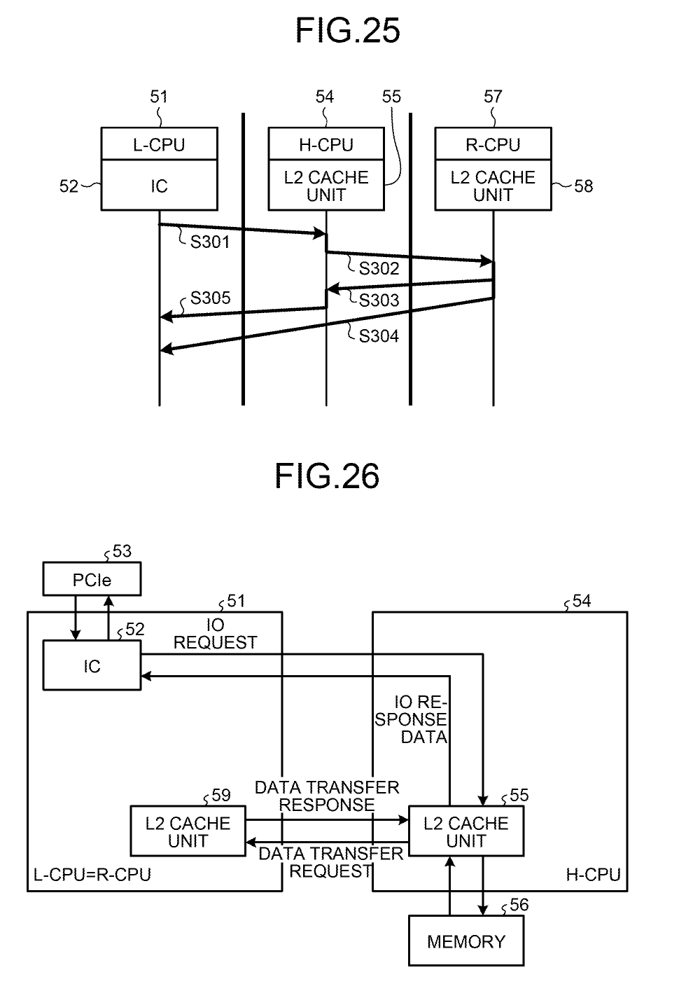

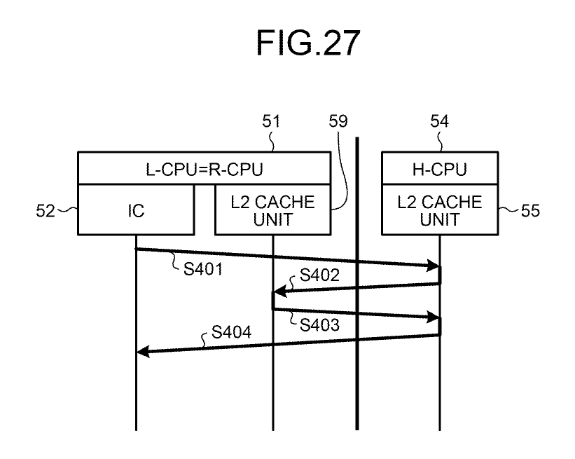

In the following, the flow of a process performed by the L2 cache unit 30 when it receives various messages will be described with reference to FIG. 21. FIG. 21 is a flowchart illustrating the flow of a process performed by an L2 cache unit when it receives a request. The flow of the process illustrated in FIG. 21 is the flow of a process performed by the L2 cache unit 30 when it receives an IO request or a data transfer request. In other words, the L2 cache unit 30 receives various types of messages in addition to the IO request or the data transfer request. If the L2 cache unit 30 receives various messages, the L2 cache unit 30 determines the request type of each received message. If the determined request type is an IO request or a data transfer request, the L2 cache unit 30 performs the following process.

For example, the L2 cache unit 30 determines whether the received message is an IO request (Step S101). If the L2 cache unit 30 determines that the received message is not an IO request (No at Step S101), the L2 cache unit 30 determines whether an L-CPU and an R-CPU are the same CPU (Step S102). Specifically, if the received message is a data transfer request, the L2 cache unit 30 determines whether an L-CPU is the CPU 20a.

If the L2 cache unit 30 determines that the L-CPU and the R-CPU are the same CPU (Yes at Step S102), the L2 cache unit 30 transmits an IO response and the data to the IC 35 in the CPU 20a (Step S103). Then, the L2 cache unit 30 transmits a data transfer response to the L2 cache unit in an H-CPU (Step S104) and ends the process. In contrast, if it is determined that the L-CPU and the R-CPU are not the same CPU (No at Step S102), the L2 cache unit 30 transmits the IO response and the data to the IC in the L-CPU (Step S105) and transmits the data transfer response to the L2 cache unit that functions as the H-CPU (Step S104).

Furthermore, if the received message is an IO request (Yes at Step S101), the L2 cache unit 30 requests the data from the received MAC 38 (Step S106) and the MAC 38 receives the data that has been acquired from the memory 10a (Step S107). Then, the L2 cache unit 30 determines whether the directory status is “R-EX” (Step S108).

Then, if the directory status is not “R-EX” (No at Step S108), the L2 cache unit 30 transmits the IO response and the data to the L-CPU (Step S109) and ends the process. Specifically, if the transfer target data is not held in one of the other different CPUs 20b to 20d, the L2 cache unit 30 transmits the data to the L-CPU without processing anything. In contrast, if the directory status is “R-EX” (Yes at Step S108), the L2 cache unit 30 transmits the data transfer request to the R-CPU that holds therein the data (Step S110), transmits the IO response to the L-CPU (Step S111), and ends the process.

[Advantage of the first embodiment] As described above, the CPU 20a includes the IC 35 that controls the IO process and includes the L2 cache unit 30. The IC 35 transmits, to one of the other different CPUs 20b to 20d, an IO request that requests a transfer of data. If the L2 cache unit 30 receives a data transfer request from corresponding one of the other different CPUs 20b to 20d, the L2 cache unit 30 determines whether the L-CPU, which is the transfer destination of the data, is the CPU 20a. Thereafter, if the L-CPU is the CPU 20a, i.e., the CPU 20a is the L-CPU and is also the R-CPU, the L2 cache unit 30 outputs the data and the IO response to the IC 35.

For example, the CPU 20a is connected to the CPU 20b, which is connected to the memory 10b, is connected to the various 10 devices, and includes the L2 cache RAM 31 that reads and holds data from the memory 10b. Furthermore, the CPU 20a includes the IC 35 that controls the acquisition of data from the various 10 devices and that transmits, when the IC 35 receives a request for a transfer of the data stored in the memory 10b from an IO device, an IO request for a transfer of the target data to the CPU 20b. Furthermore, the CPU 20a includes the L2 cache unit 30 that controls the L2 cache RAM 31. At this point, if the L2 cache unit 30 receives a data transfer request that instructs a transfer of both the IO response and the target data from the CPU 20b, the L2 cache unit 30 determines whether the destination of the IO response is the CPU 20a. If it is determined that the destination of the IO response is the CPU 20a, the L2 cache unit 30 outputs the IO response and the target data to the IC 35.

Consequently, because the CPU 20a can reduce the number of times communication is performed among the CPUs from when the IC 35 issues an IO request until the IC 35 receives data to two times, the performance of the data transfer can be improved. Furthermore, because the CPU 20a transmits the IO request once to the H-CPU and determines, when the CPU 20a receives a data transfer request, whether the L-CPU and the R-CPU are the same CPU, it is possible to reduce the number of branches in the processes performed by the CPUs. Consequently, with the CPU 20a, a process to be executed is simple and thus it is easy to design or test the circuit.

Furthermore, if the CPU 20a determines that the L-CPU is not the CPU 20a, the CPU 20a transmits the IO response and the data to an L-CPU indicated by the data transfer request. Specifically, if the CPU 20a determines that the destination of the IO response is not the CPU 20a, the CPU 20a transmits the IO response and the target data to the other CPU that functions as an L-CPU. Consequently, because the CPU 20a reduces the number of times communication is performed among the CPUs to three even if the L-CPU and the R-CPU are different, it is possible to improve the performance of the data transfer.

Furthermore, the CPU 20a outputs a data transfer response to an H-CPU. Consequently, the CPU 20a can allow the H-CPU to identify that a transfer of the data has been performed.

Furthermore, the CPU 20a receives a data transfer request that stores an L-CPU-ID therein and determines whether the L-CPU-ID stored in the data transfer request matches the ID of the CPU 20a. Specifically, the CPU 20a determines whether the ID of the CPU that is the destination of the IO response is the ID of the CPU 20a. If the L-CPU-ID stored in the data transfer request matches the ID of the CPU 20a, the CPU 20a determines that the CPU 20a is an L-CPU. Consequently, the CPU 20a can easily determine whether the CPU 20a is an L-CPU.

Furthermore, if the IC 35 in the CPU 20a receives a response that includes the data, the IC 35 determines that the process according to the IO request ends. Consequently, the CPU 20a can prevent the occurrence of, for example, an error due to the end of the process for the request even though the data has not been received.

### [b] Second Embodiment

In the above explanation, a description has been given of the embodiment according to the present invention; however, the embodiment is not limited thereto and can be implemented with various kinds of embodiments other than the embodiment described above. Therefore, another embodiment included in the present invention will be described as a second embodiment below.

(1) Format of the Messages

In the first embodiment described above, the format of the messages is illustrated in FIGS. 6 to 9; however, the embodiment is not limited thereto. The CPU 20a may also issue a message with an arbitrary format.

(2) About Embodiment

The above described functions of the L2 cache RAM 31, the memory management unit 32, the input control unit 33, and the output control unit 34 in the L2 cache unit 30 may also be used in any combination as long as the processes do not conflict with each other. For example, the L2 cache unit 30 may also includes an input-output control unit that has a function performed by both the input control unit 33 and the output control unit 34.

Furthermore, the configuration of the information processing apparatus 1 illustrated in FIG. 1 is only an example. The information processing apparatus 1 may also include an arbitrary number of SBs and CPUs and the CPUs may also have the same function as that performed by the CPU 20a. Furthermore, all of the CPUs do not need to perform the same function as that performed by the CPU 20a. For example, from among the CPUs included in the information processing apparatus 1, if some CPUs are only connected to a memory, only the CPU connected to the memory may perform the same function as that performed by the CPU 20a. Furthermore, the other CPUs may also have the function, out of the functions performed by the CPU 20a, performed as an L-CPU and an R-CPU.

According to an aspect of an embodiment of the present invention, it is possible to improve the performance of a data transfer among multiple processors.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
a cache memory that holds data from a main storage device connected to a first processor;
a first control unit that controls acquisition of data performed by a input/output device connected to the processor and that outputs, to the first processor connected to the processor when the input/output device requests a transfer of target data stored in the main storage device connected to the first processor, an input/output request that requests the transfer of the target data; and
a second control unit that controls the cache memory, that determines, when an instruction to transfer the target data and a response output by the first processor on the basis of the input/output request that has been output to the first processor is received from the first processor, whether the destination of the response is the processor, and that outputs, to the first control unit when the second control unit determines that the destination of the response is the processor, the response and the target data with respect to the input/output request.

2. The processor according to claim 1, wherein, when the second control unit determines that the destination of the response is not the processor, the second control unit transmits the response and the target data to a processor that has output the input/output request to the first processor.

3. The processor according to claim 1, wherein the second control unit outputs, to the first processor, a response to the instruction.

4. The processor according to claim 1, wherein the second control unit extracts, from the instruction, an identifier indicating the destination of the response and determines, when the extracted identifier matches the identifier of the processor, that the destination of the response is the processor.

5. The processor according to claim 1, wherein, the first control unit determines that a process according to the input/output request is ends when the first control unit receives the response and the target data.

6. An information processing apparatus comprising:
a first processor that is connected to a main storage device; and
a second processor that is connected to an input/output device and the first processor, wherein
the second processor includes
a cache memory that reads and holds data from the main storage device,
a first control unit that controls acquisition of data performed by the input/output device and that outputs, to the first processor when the input/output device requests a transfer of target data stored in the main storage device, an input/output request that requests the transfer of the target data, and
a second control unit that controls the cache memory, that determines, when an instruction to transfer the target data and a response output by the first processor on the basis of the input/output request that has been output to the first processor is received from the first processor, whether the destination of the response is the processor, and that outputs, to the first control unit when the second control unit determines that the destination of the response is the processor, the response and the target data with respect to the input/output request.

7. A control method for a processor, the control method comprising:
controlling, performed by a first control unit included in the processor, acquisition of data performed by an input/output device connected to the processor;
outputting, performed by the first control unit, to a first processor, connected to a main storage device and the processor, when the input/output device requests a transfer of target data stored in the main storage device, an input/output request that requests the transfer of the target data;
controlling, performed by a second control unit included in the processor, a cache memory that holds data from the main storage device;
determining, performed by the second control unit, when an instruction to transfer the target data and a response output by the first processor on the basis of the input/output request that has been output to the first processor is received from the first processor, whether the destination of the response is the processor and
outputting, performed by the second control unit, to the first control unit when the second control unit determines that the destination is the processor, the response and the target data with respect to the input/output request.
